(19) United States
(12) Patent Application Publication
(10) Pub. No.: US 2010/0281483 A1
(43) Pub. Date: Nov. 4, 2010

(54) PROGRAMMABLE SCHEDULING CO-PROCESSOR

(75) Inventors: Shlomo Selim Rakib, Cupertino, CA (US); Alexander Hubris, San Jose, CA (US); Muhammad Ahmed, Hayward, CA (US)

Correspondence Address: Stevens Law Group, 1754 Technology Drive, Suite #226, San Jose, CA, 95110, US

(73) Assignee: Novafora, Inc., San Jose, CA (US)

(21) Appl. No.: 12/433,824

(22) Filed: Apr. 30, 2009

(51) Int. Cl. G06F 9/46; G06F 12/00

(52) U.S. Cl. 718/102; 711/108; 712/30

(57) ABSTRACT

A scheduling co-processor for scheduling the execution of threads on a processor is disclosed. In certain embodiments, the scheduling co-processor includes one or more engines (such as lookup tables) that are programmable with a Petri-net representation of a thread scheduling algorithm. The scheduling co-processor may further include a token list to store tokens associated with the Petri-net; an enabled-thread list to indicate which threads are enabled for execution in response to particular tokens being present in the token list; and a ready-thread list to indicate which threads from the enabled-thread list are ready for execution when data and/or space availability conditions associated with the threads are satisfied.

### BACKGROUND

This invention relates to scheduling threads or processes, and more particularly to apparatus and methods for scheduling threads or processes using hardware.

Signal and media processing (also referred to herein as “data processing”) is pervasive in today's electronic devices. This is true for cell phones, media players, personal digital assistants, gaming devices, personal computers, home gateway devices, and a host of other devices. From video, image, or audio processing, to telecommunications processing, many of these devices must perform several if not all of these tasks, often at the same time.

For example, a typical “smart” cell phone may require functionality to demodulate, decrypt, and decode incoming telecommunications signals, and encode, encrypt, and modulate outgoing telecommunication signals. If the smart phone also functions as an audio/video player, the smart phone may require functionality to decode and process the audio/video data. Similarly, if the smart phone includes a camera, the device may require functionality to process and store the resulting image data. Other functionality may be required for gaming, wired or wireless network connectivity, general-purpose computing, and the like. The device may be required to perform many if not all of these tasks simultaneously.

Similarly, a “home gateway” device may provide basic services such as broadband connectivity, Internet connection sharing, and/or firewall security. The home gateway may also perform bridging/routing and protocol and address translation between external broadband networks and internal home networks. The home gateway may also provide functionality for applications such as voice and/or video over IP, audio/video streaming, audio/video recording, online gaming, wired or wireless network connectivity, home automation, VPN connectivity, security surveillance, or the like. In certain cases, home gateway devices may enable consumers to remotely access their home networks and control various devices over the Internet.

Depending on the device, many of the tasks it performs may be processing-intensive and require some specialized hardware or software. In some cases, devices may utilize a host of different components to provide some or all of these functions. For example, a device may utilize certain chips or components to perform modulation and demodulation, while utilizing other chips or components to perform video encoding and processing. Other chips or components may be required to process images generated by a camera. This may require wiring together and integrating a significant amount of hardware and software.

Currently, there is no unified architecture or platform that can efficiently perform many or all of these functions, or at least be programmed to perform many or all of these functions. Thus, what is needed is a unified platform or architecture that can efficiently perform tasks such as data modulation, demodulation, encryption, decryption, encoding, decoding, transcoding, processing, analysis, or the like, for applications such as video, audio, telecommunications, and the like. Further needed is a unified platform or architecture that can be easily programmed to perform any or all of these tasks, possibly simultaneously. Such a platform or architecture would be highly useful in home gateways or other integrated devices, such as mobile phones, PDAs, video/audio players, gaming devices, or the like.

### BRIEF DESCRIPTION OF THE DRAWINGS

In order that the advantages of the invention will be readily understood, a more particular description of the invention briefly described above will be rendered by reference to specific examples illustrated in the appended drawings. Understanding that these drawings depict only typical examples of the invention and are not therefore to be considered limiting of its scope, the invention will be described and explained with additional specificity and detail through use of the accompanying drawings, in which:

FIG. 1 is a high-level block diagram of one embodiment of a data processing architecture in accordance with the invention;

FIG. 2 is a high-level block diagram showing one embodiment of a group in the data processing architecture;

FIG. 3 is a high-level block diagram showing one embodiment of a cluster containing an array of processing elements (i.e., a VPU array);

FIG. 4 is a high-level block diagram of one embodiment of an array of processing elements inside the cluster;

FIG. 5 is a high-level block diagram showing various registers within the VPU array, and how data may be transferred between processing elements within the array using these registers;

FIG. 6 is a high-level block diagram showing a VPC (vector processor unit controller) containing a grouping module and a modification module;

FIG. 7 is a high-level block diagram showing one embodiment of a scheduling co-processor for scheduling threads on the VPU array;

FIG. 8 is a high-level block diagram showing the operation of the scheduling co-processor when programmed with a Petri-net representation of a thread scheduling algorithm;

FIG. 9A is a high-level block diagram of one embodiment of a token list;

FIG. 9B is a high-level block diagram of one embodiment of an enabled-thread list;

FIG. 9C is a high-level block diagram of one embodiment of a ready-thread list;

FIG. 10A is a high-level block diagram showing one example of a control flow graph for scheduling threads on the VPU array;

FIG. 10B is a high-level block diagram showing a Petri-net representation of the control flow graph of FIG. 8A; and

FIG. 11 is a high-level block diagram showing another embodiment of a scheduling co-processor programmed with a Petri-net representation of a thread scheduling algorithm.

### DETAILED DESCRIPTION

The present invention provides an apparatus and method for scheduling threads in a data processing system that overcome various shortcomings of the prior art. The features and advantages of the present invention will become more fully apparent from the following description and appended claims, or may be learned by the practice of the invention as set forth hereinafter.

In a first embodiment of the invention, an apparatus includes a scheduling co-processor configured to schedule threads for execution on a processor. The scheduling co-processor includes one or more lookup tables that are programmable with a Petri-net representation of a thread scheduling algorithm. The scheduling co-processor further includes a token list to store tokens associated with the Petri-net; an enabled-thread list to indicate which threads are enabled for execution in response to particular tokens being present in the token list; and a ready-thread list to indicate which threads from the enabled-thread list are ready for execution when data and/or space availability conditions associated with the threads are satisfied.

In selected embodiments, the one or more lookup tables include a token lookup table to identify threads to add to the enabled-thread list when particular tokens are present in the token list. The one or more lookup tables may further include a thread lookup table to identify threads to remove from the enabled-thread list when a thread is moved from the enabled-thread list to the ready-thread list. In certain embodiments, the thread lookup table further identifies one or more of: tokens to add to the token list when a thread is finished executing; data and/or space available conditions that must be satisfied before a thread is moved from the enabled-thread list to the ready-thread list; the priority of execution for threads listed in the thread lookup table; and parameters required to execute each thread.

In certain embodiments, the token lookup table further identifies tokens to be deleted from the token list when a thread is added to the enabled-thread list. In selected embodiments, the token lookup table is implemented in a content-addressable memory (CAM), such as a ternary content-addressable memory (TCAM), which is indexed using the token list. In certain embodiments, one or more of the token list, the enabled-thread list, and the ready-thread list are stored in one or more registers in the scheduling co-processor.

In another embodiment of the invention, an apparatus for scheduling threads in a data processing system includes a scheduling co-processor having the following: one or more engines programmable with a Petri-net representation of a thread scheduling algorithm; a token list to store tokens associated with place nodes of the Petri-net representation; and an enabled-thread list to represent transition nodes in the Petri-net to respond to particular tokens being present in the token list.

Methods corresponding to the above-described apparatus are also disclosed and claimed herein.

It will be readily understood that the components of the present invention, as generally described and illustrated in the Figures herein, may be arranged and designed in a wide variety of different configurations. Thus, the following more detailed description of the embodiments of the apparatus and methods of the present invention, as represented in the Figures, is not intended to limit the scope of the invention, as claimed, but is merely representative of selected embodiments of the invention.

Many of the functional units described in this specification are shown as modules (or functional blocks) in order to emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose of the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, specific details may be provided, such as examples of programming, software modules, user selections, or the like, to provide a thorough understanding of embodiments of the invention. One skilled in the relevant art will recognize, however, that the invention can be practiced without one or more of the specific details, or with other methods or components. In other instances, well-known structures, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

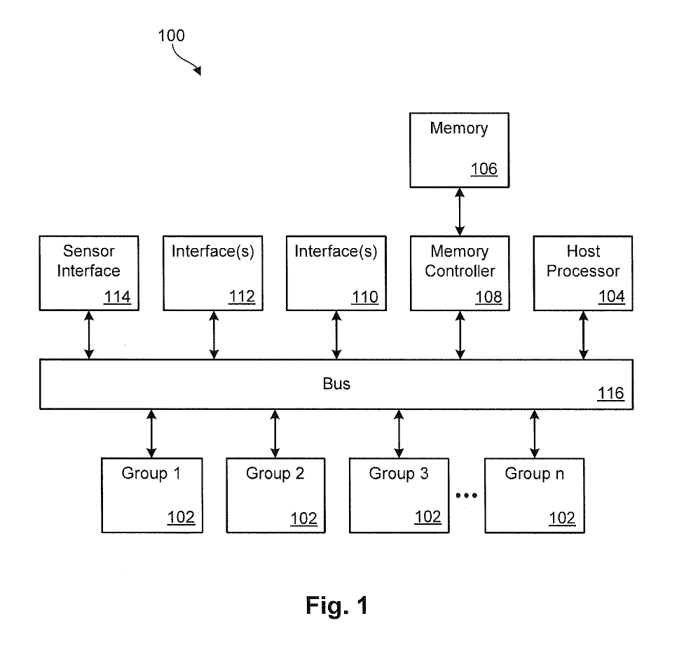

Referring to FIG. 1, one embodiment of a data processing architecture 100 in accordance with the invention is illustrated. The data processing architecture 100 may be used to process (i.e., encode, decode, transcode, analyze, process) audio or video data although it is not limited to processing audio or video data. The flexibility and configurability of the data processing architecture 100 may also allow it to be used for tasks such as data modulation, demodulation, encryption, decryption, or the like, to name just a few. In certain embodiments, the data processing architecture may perform several of the above-stated tasks simultaneously as part of a data processing pipeline.

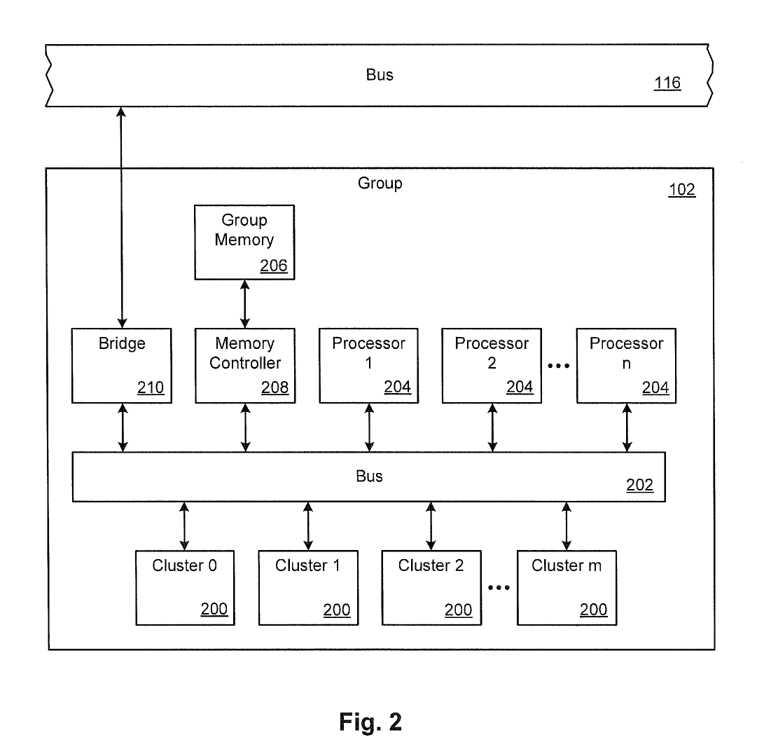

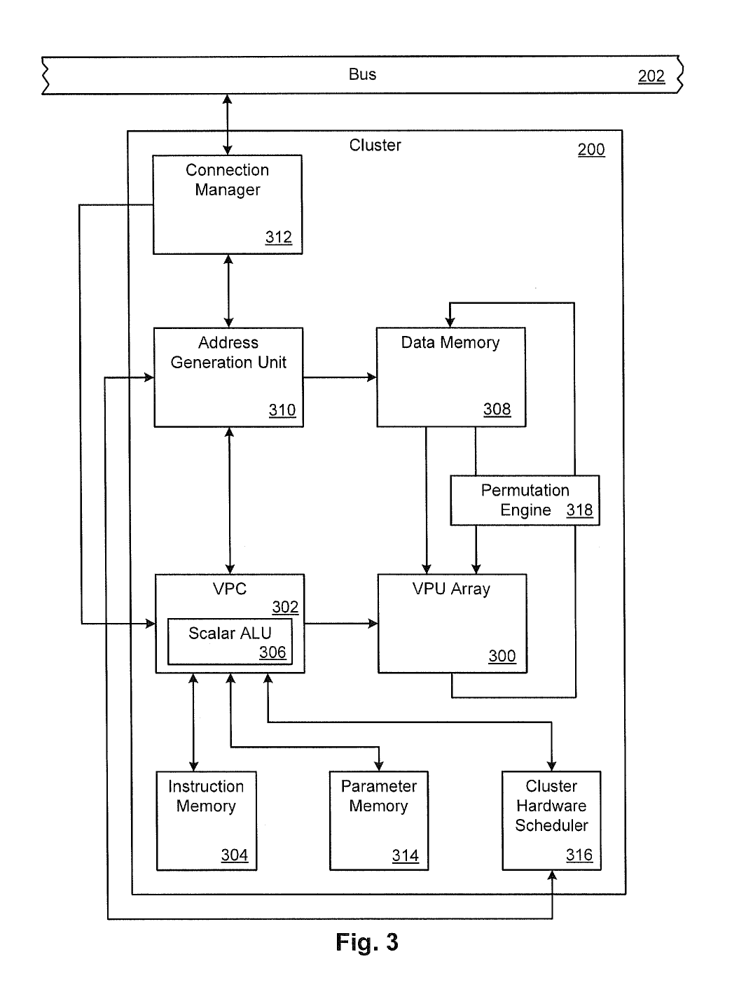

In certain embodiments, the data processing architecture 100 may include one or more groups 102, each containing one or more clusters of processing elements (as will be explained in association with FIGS. 2 and 3). By varying the number of groups 102 and/or the number of clusters within each group 102, the processing power of the data processing architecture 100 may be scaled up or down for different applications. For example, the processing power of the data processing architecture 100 may be considerably different for a home gateway device than it is for a mobile phone and may be scaled up or down accordingly.

The data processing architecture 100 may also be configured to perform certain tasks (e.g., demodulation, decryption, decoding) simultaneously. For example, certain groups and/or clusters within each group may be configured for demodulation while others may be configured for decryption or decoding. In other cases, different clusters may be configured to perform different steps of the same task, such as performing different steps in a pipeline for encoding or decoding video data. For example, where the data processing architecture 100 is used for video processing, one cluster may be used to perform motion compensation, while another cluster is used for deblocking, and so forth. How the process is partitioned across the clusters is a design choice that may differ for different applications. In any case, the data processing architecture 100 may provide a unified platform for performing various tasks or processes without the need for supporting hardware.

In certain embodiments, the data processing architecture 100 may include one or more processors 104, memory 106, memory controllers 108, interfaces 110, 112 (such as PCI interfaces 110 and/or USB interfaces 112), and sensor interfaces 114. A bus 116, such as a crossbar switch 116, may be used to connect the components together. A crossbar switch 116 may be useful in that it provides a scalable interconnect that can mitigate possible throughput and contention issues.

In operation, data, such as video data, may be streamed through the interfaces 110, 112 into a data buffer memory 106. This data may, in turn, be streamed from the data buffer memory 106 to group memories 206 (as shown in FIG. 2) and then to cluster memories 308 (as shown in FIG. 3), each forming part of a memory hierarchy. Once in the cluster memories 308, the data may be operated on by arrays 300 of processing elements (i.e., VPU arrays 300). The groups and clusters will be described in more detail in FIGS. 2 and 3. In certain embodiments, a data pipeline may be created by streaming data from one cluster to another, with each cluster performing a different function (e.g., motion compensation, deblocking, etc.). After the data processing is complete, the data may be streamed back out of the cluster memories 308 to the group memories 206, and then from the group memories 206 to the data buffer memory 106 and out through the one or more interfaces 110, 112.

In selected embodiments, a host processor 104 (e.g., a MIPS processor 104) may control and manage the actions of each of the components 102, 108, 110, 112, 114 and act as a supervisor for the data processing architecture 100. The host processor 104 may also program each of the components 102, 108, 110, 112 with a particular application (video processing, audio processing, telecommunications processing, modem processing, etc.) before data processing begins.

In selected embodiments, a sensor interface 114 may interface with various sensors (e.g., IRDA sensors) which may receive commands from various control devices (e.g., remote controls). The host processor 104 may receive the commands from the sensor interface 114 and take appropriate action. For example, if the data processing architecture 100 is configured to decode television channels and the host processor 104 receives a command to begin decoding a particular television channel, the processor 104 may determine what the current loads of each of the groups 102 are and determine where to start a new process. For example, the host processor 104 may decide to distribute this new process over multiple groups 102, keep the process within a single group 102, or distribute it across all of the groups 102. In this way, the host processor 104 may perform load-balancing between the groups 102 and determine where particular processes are to be performed within the data processing architecture 100.

Referring to FIG. 2, one embodiment of a group 102 is illustrated. In general, a group 102 may be a semi-autonomous data processing unit that may include one or more clusters 200 of processing elements. The components of the group 102 may communicate over a bus 202, such as a crossbar switch 202. The internal components of the clusters 102 will be explained in more detail in association with FIG. 3. In certain embodiments, a group 102 may include one or more management processors 204 (e.g., MIPS processors 204), group memories 206 and associated memory controllers 208. A bridge 210 may connect the group 102 to the primary bus 116 illustrated in FIG. 1. Among other duties, the management processors 204 may perform load balancing across the clusters 200 and dispatch tasks to individual clusters 200 based on their availability. Prior to dispatching a task, the management processors 204 may, if needed, send parameters to the clusters 200 in order to program them to perform particular tasks. For example, the management processors 204 may send parameters to program an address generation unit, a cluster scheduler, or other components within the clusters 200, as shown in FIG. 3.

Referring to FIG. 3, in selected embodiments, a cluster 200 in accordance with the invention may include an array 300 of processing elements (i.e., a vector processing unit (VPU) array 300). An instruction memory 304 may store instructions associated with threads running on the cluster 200 and intended for execution on the VPU array 300. A vector processor unit controller (VPC) 302 may fetch instructions from the instruction memory 304, decode the instructions, and transmit the decoded instructions to the VPU array 300 in a “modified SIMD” fashion. The VPC 302 may act in a “modified SIMD” fashion by grouping particular processing elements and applying an instruction modified to each group. This may allow different processing elements to handle the same instruction differently. For example, this mechanism may be used to cause half of the processing elements to perform an ADD instruction while the other half performs a SUB instruction, all in response to a single instruction from the instruction memory 304. This feature adds a significant amount of flexibility and functionality to the cluster 200.

The VPC 302 may have associated therewith a scalar ALU 306 which may perform scalar computations, perform control-related functions, and manage the operation of the VPU array 300. For example, the scalar ALU 306 may reconfigure the processing elements by modifying the groups that the processing elements belong to or designating how the processing elements should handle instructions based on the group they belong to.

The cluster 200 may also include a data memory 308 storing vectors having a defined number (e.g., sixteen) of elements. In certain embodiments, the number of elements in each vector may be equal to the number of processing elements in the VPU array 300, allowing each processing element within the array 300 to operate on a different vector element in parallel. Similarly, in selected embodiments, each vector element may include a defined number (e.g., sixteen) of bits. For example, where each vector includes sixteen elements and each element includes sixteen bits, each vector would include 256 bits. The number of bits in each element may be equal to the width (e.g., sixteen bits) of the data path between the data memory 308 and each processing element. It follows that if the data path between the data memory 308 and each processing element is 16-bits wide, the data ports (i.e., the read and write ports) to the data memory 308 may be 256-bits wide (16 bits for each of the 16 processing elements). These numbers are presented only by way of example are not intended to be limiting.

In selected embodiments, the cluster 200 may include an address generation unit 310 to generate real addresses when reading data from the data memory 308 or writing data back to the data memory 308. In selected embodiments, the address generation unit 310 may generate addresses in response to read/write requests from either the VPC 302 or connection manager 312 in a way that is transparent to the VPC 302 and connection manager 312. The cluster 200 may include a connection manager 312, communicating with the bus 202, whose primary responsibility is to transfer data into and out of the cluster data memory 308 to/from the bus 202.

In selected embodiments, instructions fetched from the instruction memory 304 may include a multiple-slot instruction (e.g., a three-slot instruction). For example, where a three-slot instruction is used, up to two (i.e., 0, 1, or 2) instructions may be sent to each processing element and up to one (i.e., 0 or 1) instruction may be sent to the scalar ALU 306. Instructions sent to the scalar ALU 306 may, for example, be used to change the grouping of processing elements, change how each group of processing elements should handle a particular instruction, or change the configuration of a permutation engine 318. In certain embodiments, the processing elements within the VPU array 300 may be considered parallel-semantic, variable-length VLIW (very long instruction word) processors, where the packet length is at least two instructions. Thus, in certain embodiments, the processing elements in the VPU array 300 may execute at least two instructions in parallel in a single clock cycle.

In certain embodiments, the cluster 200 may further include a parameter memory 314 to store parameters of various types. For example, the parameter memory 314 may store a processing element (PE) map to designate which group each processing element belongs to. The parameters may also include an instruction modifier designating how each group of processing elements should handle a particular instruction. In selected embodiments, the instruction modifier may designate how to modify at least one operand of the instruction, such as a source operand, destination operand, or the like.

In selected embodiments, the cluster 200 may be configured to execute multiple threads simultaneously in an interleaved fashion. In certain embodiments, the cluster 200 may have a certain number (e.g., two) of active threads and a certain number (e.g., two) of dormant threads resident on the cluster 200 at any given time. Once an active thread has finished executing, a cluster scheduler 316 may determine the next thread to execute. In selected embodiments, the cluster scheduler 316 may use a Petri net or other tree structure to determine the next thread to execute, and to ensure that any necessary conditions are satisfied prior to executing a new thread. In certain embodiments, the group processor 204 (shown in FIG. 2) or host processor 104 may program the cluster scheduler 316 with the appropriate Petri nets/tree structures prior to executing a program on the cluster 200.

Because a cluster 200 may execute and finish threads very rapidly, it is important that threads can be scheduled in an efficient manner. In certain embodiments, an interrupt may be generated each time a thread has finished executing so that a new thread may be initiated and executed. Where threads are relatively short, the interrupt rate may become so high that thread scheduling has the potential to undesirably reduce the processing efficiency of the cluster 200. Thus, apparatus and methods are needed to improve scheduling efficiency and ensure that scheduling does not create bottlenecks in the system. To address this concern, in selected embodiments, the cluster scheduler 316 may be implemented in hardware as opposed to software. This may significantly increase the speed of the cluster scheduler 316 and ensure that new threads are dispatched in an expeditious manner. Nevertheless, in certain cases, the cluster hardware scheduler 316 may be bypassed and scheduling may be managed by other components (e.g., the group processor 204).

In certain embodiments, the cluster 200 may include permutation engine 318 to realign data that it read from or written to the data memory 308. The permutation engine 318 may be programmable to allow data to a reshuffled in a desired order before or after it is processed by the VPU array 300. In certain embodiments, the programming for the permutation engine 318 may be stored in the parameter memory 314. The permutation engine 318 may permute data having a width (e.g., 256 bits) corresponding to the width of the data path between the data memory 308 and the VPU array 300. In certain embodiments, the permutation engine 318 may be configured to permute data with a desired level of granularity. For example, the permutation engine 318 may reshuffle data on a byte-by-byte or element-by-element basis or other desired level of granularity. Using this technique, the elements within a vector may be reshuffled as they are transmitted to or from the VPU array 300.

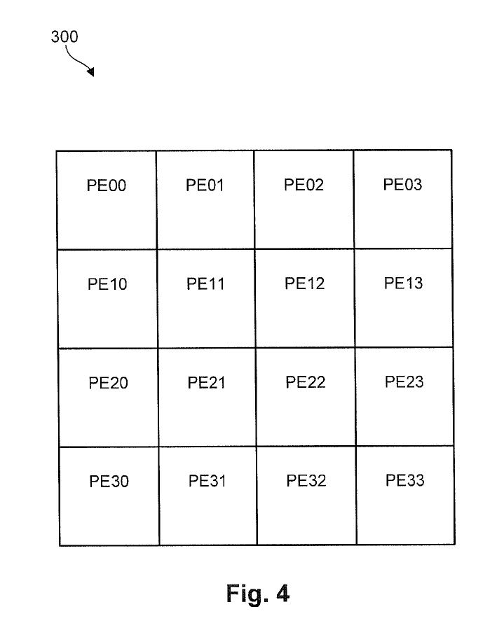

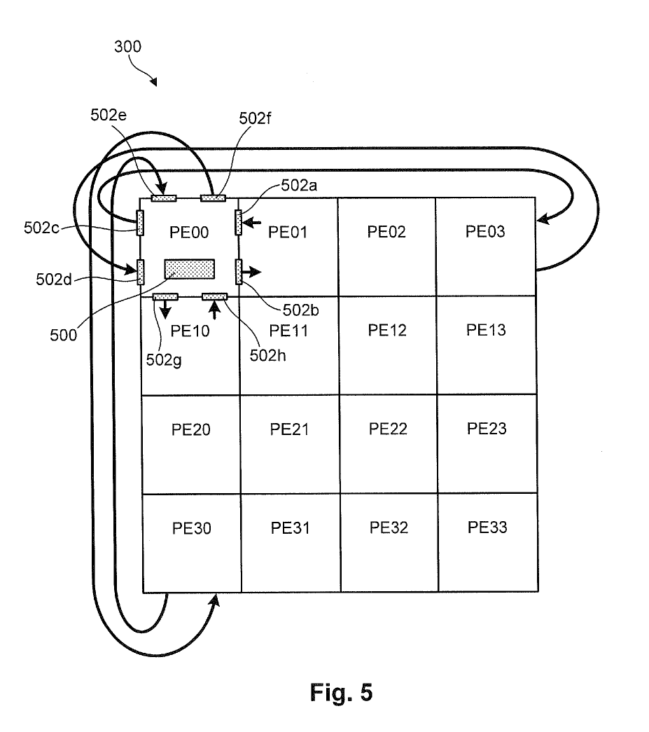

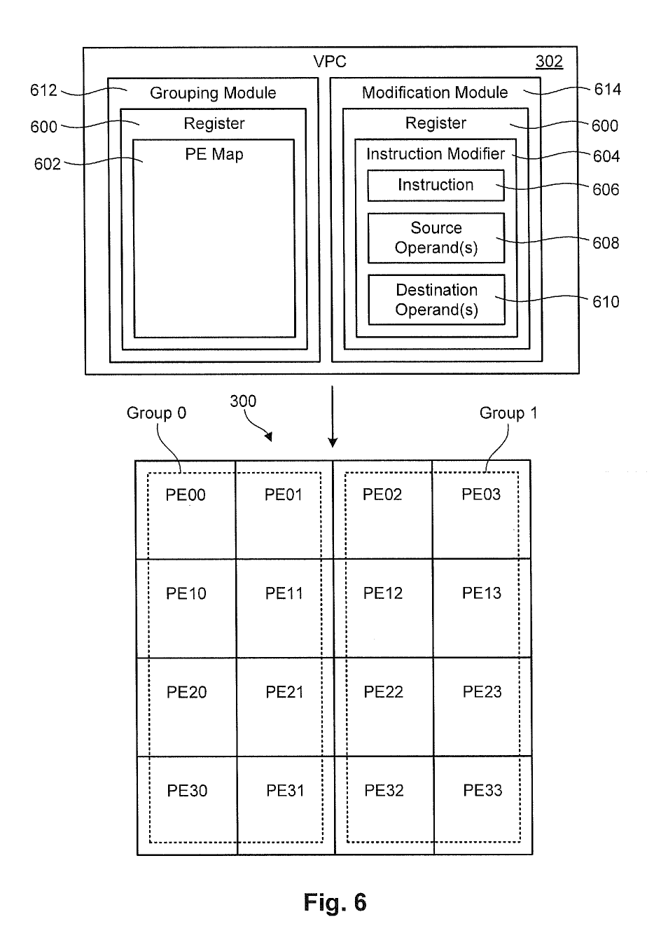

Referring to FIG. 4, as previously mentioned, the VPU array 300 may include an array of processing elements, such as an array of sixteen processing elements (hereinafter labeled PE00 through PE33). As previously mentioned, these processing elements may simultaneously execute the same instruction on multiple data elements (i.e., a vector of data elements) in a “modified SIMD” fashion, as will be explained in more detail in association with FIG. 6. In the illustrated embodiment, the VPU array 300 includes sixteen processing elements arranged in a 4×4 array, with each processing element configured to process a sixteen bit data element. This arrangement of processing elements allows data to be passed between the processing elements in a specified manner as will be discussed in association with FIG. 5. Nevertheless, the VPU array 300 is not limited to a 4×4 array. Indeed, the cluster 200 may be configured to function with other n×n or even n×m arrays of processing elements, with each processing element configured to process a data element of a desired size.

Referring to FIG. 5, in selected embodiments, each of the processing elements of the VPU array 300 may include various registers to store data or instructions. For example, the processing elements may include one or more internal general purpose registers 500 in which to store data. In addition, each of the processing elements may include one or more exchange registers 502 to transfer data between the processing elements. This may allow the processing elements to communicate with neighboring processing elements without the need to save the data to the data memory 308 and then reload the data into the internal registers 500 of a neighboring processing element.

For example, in selected embodiments, an exchange register 502a may have a read port that is coupled to PE00 and a write port that is coupled to PE01, allowing data to be transferred from PE01 to PE00. Similarly, an exchange register 502b may have a read port that is coupled to PE01 and a write port that is coupled to PE00, allowing data to be transferred from PE00 to PE01. This enables two-way communication between adjacent processing elements PE00 and PE01.

Similarly, for those processing elements on the edge of the array 300, the processing elements may be configured for “wrap-around” communication. For example, in selected embodiments, an exchange register 502c may have a write port that is coupled to PE00 and a read port that is coupled to PE03, allowing data to be transferred from PE00 to PE03. Similarly, an exchange register 502d may have a write port that is coupled to PE03 and a read port that is coupled to PE00, allowing data to be transferred from PE03 to PE00. Similarly, exchange registers 502e, 502f may enable two-way communication between processing elements PE00 and PE30 and exchange registers 502g, 502h may enable two-way communication between processing elements PE00 and PE10.

In certain embodiments, the cluster 200 may be configured such that data may be loaded from data memory 308 into either the internal registers 500 or the exchange registers 502 of the VPU array 300. The cluster 200 may also be configured such that data may be loaded from the data memory 308 into the internal registers 500 and exchange registers 502 simultaneously. Similarly, the cluster 200 may also be configured such that data may be transferred from either the internal registers 500 or the exchange registers 502 to data memory 308.

Referring to FIG. 6, as previously mentioned, in selected embodiments, the VPU array 300 may be configured to act in a “modified SIMD” fashion. This may enable certain processing elements to be grouped together and the groups of processing elements to handle instructions differently. To provide this functionality, in selected embodiments, the VPC 302 may contain a grouping module 612 and a modification module 614. In general, the grouping module 612 may be used to assign each processing element within the VPU array 300 to one of several groups. A modification module 614 may designate how each group of processing elements should handle different instructions.

FIG. 6 shows one example of a method for implementing the grouping module 612 and modification module 614. In selected embodiments, the grouping module 612 may include a PE map 602 to designate which group each processing element belongs to. This PE map 602 may, in certain embodiments, be stored in a register 600 on the VPC 302. This register 600 may be read by each processing element so that it can determine which group it belongs to. For example, in selected embodiments, the PE map 602 may store two bits for each processing element (e.g., 32 bits total for 16 processing elements), allowing each processing element to be assigned to one of four groups (groups 0, 1, 2, and 3). This PE map 602 may be updated as needed by the scalar ALU 306 to change the grouping.

In selected embodiments, the modification module 614 may include an instruction modifier 604 to designate how each group should handle an instruction 606. Like the PE map 602, this instruction modifier 604 may, in certain embodiments, be stored in a register 600 that may be read by each processing element in the array 300. For example, consider a VPU array 300 where the PE map 602 designates that the first two columns of PEs belong to “group 0” and the second two columns of PEs belong to “group 1.” An instruction modifier 604 may designate that group 0 should handle an ADD instruction as an ADD instruction, while group 1 should handle the ADD instruction as a SUB instruction. This will allow each group to handle the ADD instruction differently. Although the ADD instruction is used in this example, this feature may be used for a host of different instructions.

In certain embodiments, the instruction modifier 604 may also be configured to modify a source operand 608 and/or a destination operand 610 of an instruction 606. For example, if an ADD instruction is designed to add the contents of a first source register (R1) to the contents of a second source register (R2) and to store the result in a third destination register (R3), the instruction modifier 604 may be used to modify any or all of these source and/or destination operands. For example, the instruction modifier 604 for a group may modify the above-described instruction such that a processing element will use the source operand in the register (R5) instead of R1 and will save the destination operand in the destination register (R8) instead of R3. In this way, different processing elements may use different source and/or destination operands 608, 610 depending on the group they belong to.

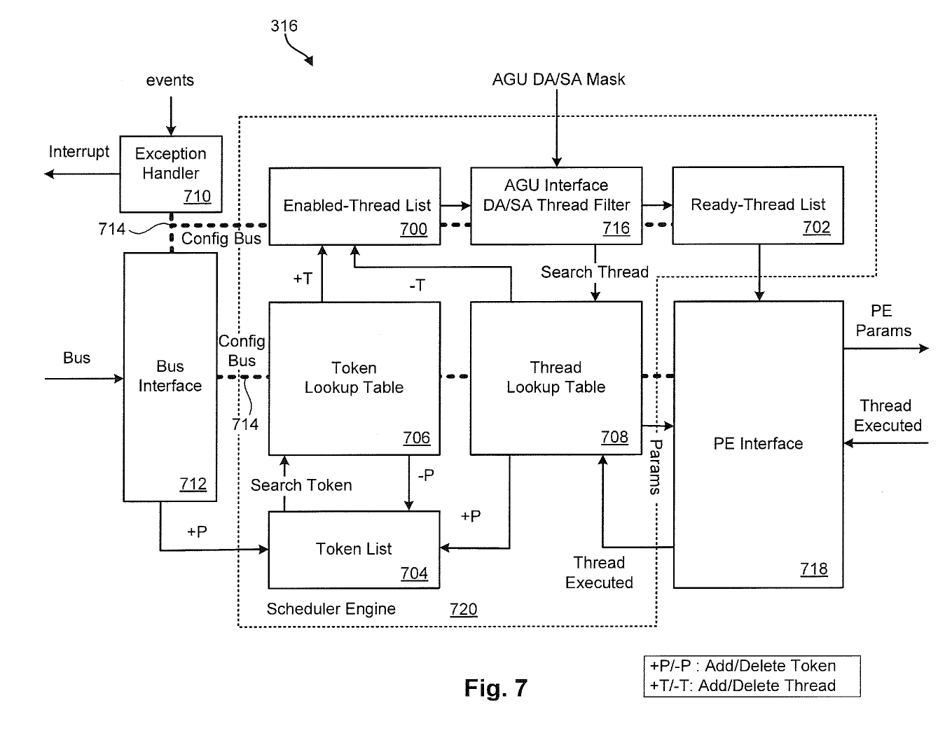

Referring to FIG. 7, as previously mentioned, in selected embodiments, the cluster hardware scheduler 316 may be implemented in hardware as opposed to software to significantly improve speed and ensure that threads are scheduled in an expeditious manner. In selected embodiments, the cluster hardware scheduler 316 is implemented as a hardware-based scheduling co-processor 316, one embodiment of which is illustrated in FIG. 7. This scheduling co-processor 316 may manage and schedule a set of threads (belonging to one or more processes) to execute on the cluster VPU array 300.

In one embodiment of the invention, a scheduling co-processor 316 in accordance with the invention may include the following lists and tables: an enabled-thread list 700, a ready-thread list 702, a token list 704, a token lookup table 706, and a thread lookup table 708. In certain embodiments, each of the enabled-thread list 700, the ready-thread list 702, and the token list 704 are implemented in hardware registers, although other memory elements may also be used. Similarly, in selected embodiments, the token lookup table 706 is implemented in a content-addressable memory (CAM), and more particularly a ternary content-addressable memory (TCAM), which may be implemented with flip-flops. Unlike binary CAMs, which use data search words comprised entirely of “1”s and “0”s, a TCAM enables use of a third matching state of “X” or “don't care” for one or more bits in the stored data search word, thus adding flexibility to the search. The thread lookup table 708 may, in certain embodiments, be implemented in a static random access memory (SRAM).

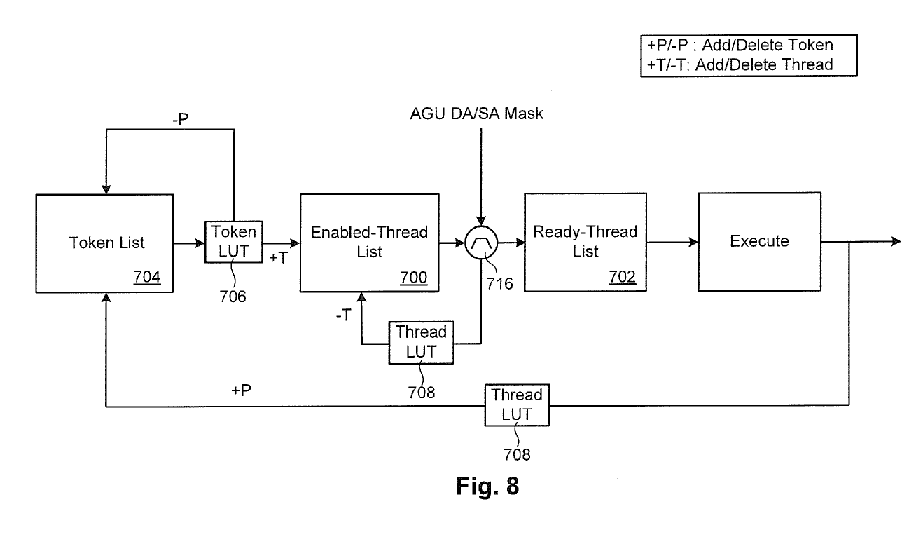

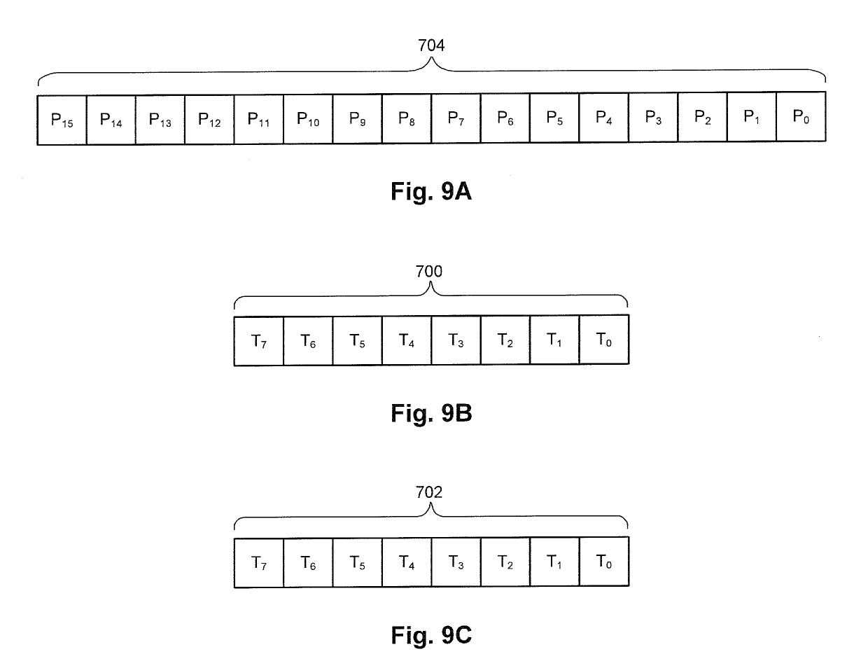

The token lookup table 706 and thread lookup table 708 may be programmed with a Petri-net representation of a thread scheduling algorithm, as will be explained in more detail hereafter. In such a representation, threads (T) are represented as transition nodes. These threads are enabled when specific tokens (P) are present in place nodes. Once threads are enabled, these threads may be considered “ready” to be executed on the VPU array 300 when data availability (DA) and space availability (SA) conditions associated with the threads are satisfied. This process will explained with more specificity in association with FIGS. 8, 9A, 9B, and 9C. FIG. 8 provides a more detailed explanation of the operation of the scheduling co-processor 316. FIGS. 9A through 9C show a token list 704, an enabled-thread list 700, and a ready-thread list 702, respectively.

Referring to FIG. 8, while also referring generally to FIGS. 9A, 9B, and 9C, threads (T0, T1, T2 . . . T7) may be initially enabled (added to the enabled-thread list 700) by an external processor or through the execution of a thread. When a thread is executed, tokens may be added (+P) to one or more place nodes (P0, P1, P2 . . . P15) in the token list 704.

When tokens in the token list 704 are updated or changed, the token list 704 may be looked up in the token lookup table 706. The token lookup table 706 stores entries indexed by tokens present in the token list 704 (i.e., the token list 704 provides the data search word to look up entries in the token lookup table 706). Each entry in the token lookup table 706 identifies threads to add to the enabled-thread list 700 when particular tokens are present in the token list 704. When a thread is added (+T) to the enabled-thread list 700, the scheduling co-processor 316 removes the tokens (−P) of the matching entry from the token list 704. For each thread in the enabled-thread list 700, the scheduling co-processor 316 checks whether data availability (DA) and space availability (SA) conditions needed to execute the thread are satisfied. If data dependencies for a thread are satisfied, the thread may be moved to the ready-thread list 702 where it is deemed “ready” for execution.

While a thread is moved to the ready-thread list 702, the scheduling co-processor 316 looks up the thread in the thread lookup table 708 (indexed by thread) to obtain a list of one or more threads to be removed from the enabled−thread list 700 (-T). These threads may then be removed from the enabled-thread list 700. The scheduling co-processor 316 may be configured to keep the ready-thread list 702 sorted by highest priority to execute on the VPU array 300. This priority information may be stored in the thread lookup table 708 for each thread. When the VPU array 300 is idle, the highest priority thread from the ready-thread list 702 may be executed on the VPU array 300. After the thread is executed, one or more tokens (identified by looking up the executed thread in the thread lookup table 708) may be added to the token list 704. The above-listed steps may be continued until the process is disabled or process iteration conditions are satisfied. In certain embodiments, a process may run indefinitely if no stop condition is specified.

The enabled-thread list 700, ready-thread list 702, and token list 704 illustrated in FIGS. 9A through 9C list eight threads and provide sixteen places for tokens respectively. However, the number of threads and places in the enabled-thread list 700, ready-thread list 702, and token list 704 is ultimately a design choice which may differ for different applications. The number of entries in the lookup tables 706, 708 may also vary accordingly. Thus, the illustrated lists 700, 702, 704 and lookup tables 706, 708 are presented by way of example and are not intended to be limiting.

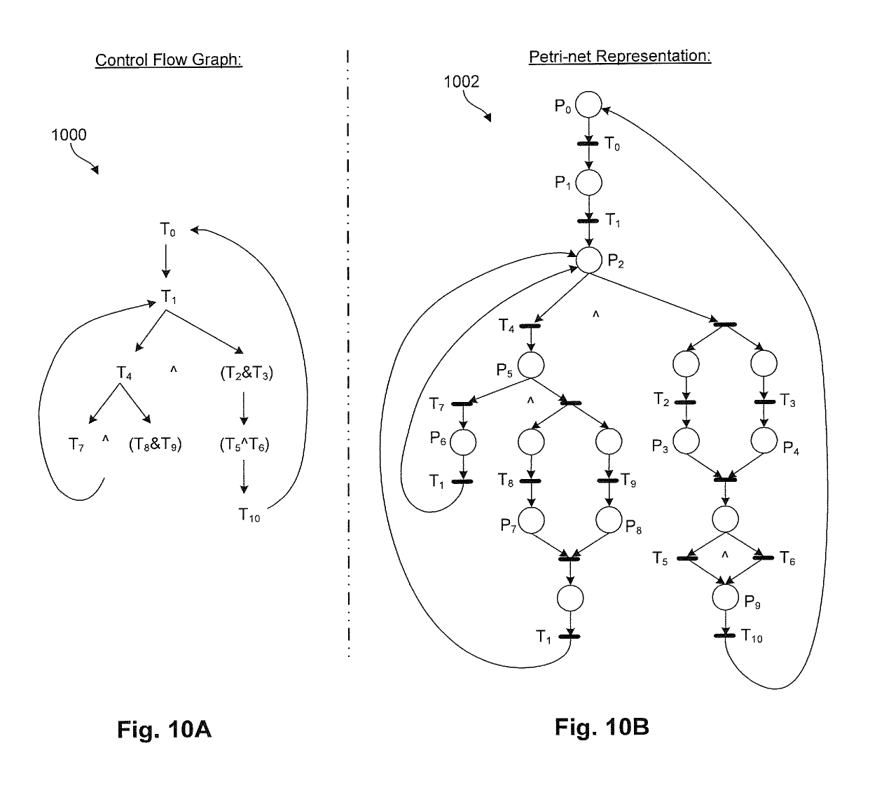

Referring to FIGS. 10A and 10B, one example of a control flow graph 1000 for a thread scheduling algorithm, and a Petri-net representation 1002 of the control flow graph 1000, are illustrated. The control flow graph 1000 and Petri-net representation 1002 show the general function of the scheduling co-processor 316. The “̂” operator in the control flow graph 1000 represents an “exclusive or.” As shown in FIG. 10B, the Petri-net representation 1002 references a certain number of threads, in this example threads T0, T1, T2 . . . T10. These threads are enabled for execution when tokens are present in a certain number of place nodes, in this example P0, P1, P2 . . . P9. In general, a thread is executed when a token or tokens are present in the place or places immediately above the transition corresponding to the thread. The execution of the thread generates one or more tokens which may then be inserted into the place or places below the thread.

The places and transitions in the Petri-net representation 1002 that are left unnamed act as dummy nodes. For example, the dummy transition node on the right branch of the place node P2 does not indicate any thread and the place nodes immediately below this dummy transition node are not used in the lookup tables 706, 708 used by the scheduling co-processor 316. Dummy nodes may be used to translate a control flow graph 1000 into a Petri-net representation 1002 but may include redundant information that is not needed by the scheduling co-processor 316.

The Petri-net representation 1002 in FIG. 10B describes the following execution path outline:
1. If a token is present in P0, thread T0 is enabled for execution.
2. Once T0 is executed, a token is added to P1.
3. If a token is present in P1, thread T1 is enabled for execution.
4. Once T1 is executed, a token is added to P2.
5. If a token is present in P2, threads T2, T3, and T4 are enabled for execution.
6. Thread T4 is executed or threads T2 and T3 are executed.
   a. If thread T4 is ready for execution, threads T2 and T3 are removed from the enabled-thread list. When thread T4 is executed, a token is added to P5.
      i. If a token is present in P5, threads T7, T8, and T9 are enabled for execution.
         1) If thread T7 is ready for execution, threads T8 and T9 are removed from the enabled-thread list. When thread T7 is executed, a token is added to P6.
            a) If a token is present in P6, thread T1 is enabled for execution.
            b) Loop back to step 4.
         2) If thread T8 is ready for execution, thread T7 is removed from the enabled-thread list. When thread T8 is executed, a token is added to P7.
            a) When thread T9 executes, a token is added to P8 (thread T7 has already been removed from the enabled-thread list).
            b) If tokens are present in P7 and P8, thread T1 is enabled for execution.
            c) Loop back to step 4.
         3) If thread T9 is ready for execution, thread T7 is removed from the enabled-thread list. When thread T9 is executed, a token is added to P8.
            a) When thread T8 executes, a token is added to P7 (thread T7 has already been removed from the enabled-thread list).
            b) If tokens are present in P7 and P8, thread T1 is enabled for execution.
            c) Loop back to step 4.
   b. If thread T2 is ready for execution, thread T4 is removed from the enabled-thread list. When thread T2 is executed, a token is added to P3.
      i. When thread T3 executes, a token is added to P4 (thread T4 has already been removed from the enabled-thread list).
      ii. If tokens are present in P3 and P4, threads T5 and T6 are enabled for execution.
         1) If thread T5 is ready for execution, thread T6 is removed from the enabled-thread list. When thread T5 is executed, a token is added to P9.
            a) If a token is present in P9, then thread T10 is enabled for execution.
            b) If thread T10 is executed, a token is added to P0.
            c) If a token is present in P0, thread T0 is enabled for execution and a process iteration is complete.
            i) Check for process iteration completion if so configured. If process iteration completion check is satisfied, stop scheduling for this process and generate notification of the event. If not satisfied, loop back to step 2.
         2) If thread T6 is ready for execution, thread T5 is removed from the enabled-thread list. When thread T6 is executed, a token is added to P9.
            a) If a token is present in P9, thread T10 is enabled for execution.
            b) If thread T10 is executed, a token is added to P0.
            c) If a token is present in P0, thread T0 is enabled for execution and a process iteration is complete.
            i) Check for process iteration completion if so configured. If process iteration completion check is satisfied, stop scheduling for this process and generate notification of the event. If not satisfied, loop back to step 2.
   c. If thread T3 is ready for execution, thread T4 is removed from the enabled-thread list. When thread T3 is executed, a token is added to P4.
      i. When thread T2 executes, a token is added to P3 (thread T4 has already been removed from the enabled-thread list).
      ii. If tokens are present in P3 and P4, threads T5 and T6 are enabled for execution.
         1) If thread T5 is ready for execution, thread T6 is removed from the enabled-thread list. When thread T5 is executed, a token is added to P9.
            a) If a token is present in P9, thread T10 is enabled for execution.
            b) If thread T10 is executed, a token is added to P0.
            c) If a token is present in P0, thread T0 is enabled for execution and a process iteration is complete.
            i) Check for process iteration completion if so configured. If process iteration completion check is satisfied, stop scheduling for this process and generate notification of the event. If not satisfied, loop back to step 2.
         2) If thread T6 is ready for execution, thread T5 is removed from the enabled-thread list. When thread T6 is executed, a token is added to P9.
            a) If a token is present in P9, thread T10 is enabled for execution.
            b) If thread T10 is executed, a token is added to P0.
            c) If a token is present in P0, thread T0 is enabled for execution and a process iteration is complete.
            i) Check for process iteration completion if so configured. If process iteration completion check is satisfied, stop scheduling for this process and generate notification of the event. If not satisfied, loop back to step 2.

The control flow graph 1000 illustrated in FIG. 10A may be represented in the scheduling co-processor 316 using the following thread lookup table 708 and token lookup table 706:

TABLE 1
Thread Lookup Table

| Thread | −T (Delete Thread) | +P (Add Token) |
|---|---|---|
| T0 | — | P1 |
| T1 | — | P2 |
| T2 | T4 | P3 |
| T3 | T4 | P4 |
| T4 | T2, T3 | P5 |
| T5 | T6 | P9 |
| T6 | T5 | P9 |
| T7 | T8, T9 | P6 |
| T8 | T7 | P7 |
| T9 | T7 | P8 |
| T10 | — | P0 |

TABLE 2
Token Lookup Table

| Token Tag | +T (Add Thread) | Start |
|---|---|---|
| P0 | T0 | X |
| P1 | T1 | — |
| P2 | T2, T3, T4 | — |
| P5 | T7, T8, T9 | — |
| P3, P4 | T5, T6 | — |
| P6 | T1 | — |
| P7, P8 | T1 | — |
| P9 | T10 | — |

The lookup tables shown above are presented only by way of example and are not intended to be limiting. In addition to the data illustrated above, each entry in the thread lookup table 708 may also include an AGU DA/SA mask specifying which AGU indicators to examine in order to determine whether the necessary data and space availability conditions are satisfied. Each entry in the token lookup table 706 may also include a token tag mask indicating which tokens to look for when searching for a matching entry in the token lookup table. For example, referring to FIG. 9A, the tag mask may indicate that tokens should be present in some subset of the places in the token list 704 in order for a match to be found in the token lookup table 706. As previously mentioned, the thread lookup table 708 may also contain information with regard to threads to delete, thread priority, and tokens to add to the token list 704 when a thread is executed.

Referring again to FIG. 7, in addition to the lists 700, 702, 704 and lookup tables 706, 708 previously described, the scheduling co-processor 316 may also include an exception handler 710 to enable the scheduling co-processor 316 to receive exceptions that are generated internally or generated by external sources such as the AGU 310 or VPC 302. In certain cases, these exceptions may allow the scheduling co-processor 316 to stop scheduling threads and freeze and/or save the state of the scheduling co-processor 316. In other cases, the scheduling co-processor 316 may perform a state save (so the problem can be examined later) and then continue operating in the normal manner.

A bus interface 712 may allow the scheduling co-processor 316 to communicate with a bus or other external device. This may allow an external device, such as an external processor, to program the scheduling co-processor 316 with a desired thread scheduling algorithm. In selected embodiments, the scheduling co-processor 316 may include a configuration bus 714 to allow the various components of the scheduling co-processor 316 to be programmed. For example, the token lookup table 706 and thread lookup table 708 may be programmed with different Petri-net representations of thread scheduling algorithms using the configuration bus 714. The scheduling co-processor 316 may also include an AGU interface DA/SA thread filter 716. This filter 716 may, using the DA/SA mask specified for a thread in the thread lookup table 708, check whether data and/or space availability conditions are satisfied in order for a particular thread to execute.

The PE interface 718 may schedule the execution of a thread with the VPC 302 and send parameters to the VPC 302 that are necessary for the thread to execute. These parameters may include, for example, the PE grouping or instruction modifier discussed in association with FIG. 6, among other parameters. This may also include identifying the location in the instruction memory 304 where the thread to be executed is stored. Once the thread is successfully executed, the VPC 302 may notify the PE interface 718 that the thread has finished executing. Upon receiving this notification, one or more tokens (identified by looking up the executed thread in the thread lookup table 708) may be added to the token list 704.

In selected embodiments, the enabled thread list 700, ready-thread list 702, token list 704, token lookup table 706, and thread lookup table 708 all form part of a scheduler engine 720. In selected embodiments, the scheduling co-processor 316 may include multiple scheduler engines 720. For example, where the VPU array 300 is configured to support interleaved multi-threading (where the VPU array 300 switches between threads of different processes during each cycle), the scheduling co-processor 316 may include a scheduler engine 720 for each process that is running on the VPU array 300 in an interleaved fashion.

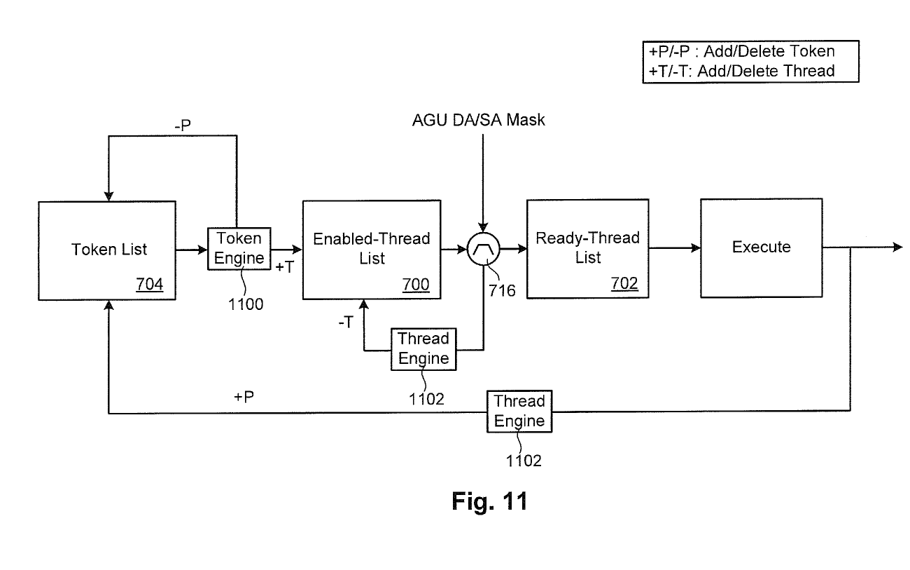

Referring to FIG. 11, the scheduling co-processor illustrated in FIGS. 7 and 8 simply illustrates one embodiment of a scheduling co-processor in accordance with the invention. In reality, the scheduling co-processor may use other mechanisms other than the lookup tables 706, 708 to add/delete tokens and/or threads from the various lists 700, 702, 704. These mechanisms may be generally referred to as a token engine 1100 and a thread engine 1102, which may be programmable with a Petri-net representation of a thread scheduling algorithm. In certain embodiments, this Petri-net representation may Docket No.: NOVA-03200 be stored in the form of firmware in the scheduling co-processor. One embodiment of the token engine 1100 and the thread engine 1102 are the token lookup table 706 and thread lookup table 708 previously discussed. In other embodiments, the token engine 1100 and thread engine 1102 may include matrix multiplication hardware, sets of programmable equations or other math-like functions, sets of interconnected logic gates, or other mechanisms that can accept as inputs a first of set of values and output a second set of values corresponding to the first set of values. More specifically, the token engine 1100 may receive as inputs the tokens in the token list 704 and output corresponding threads that need to be added to the enabled-thread list 700 as a result of particular tokens being present.

When a thread is moved to the ready-thread list 702, the scheduling co-processor 316 may use the thread engine 1102 to obtain a list of one or more threads to be removed from the enabled-thread list 700. These threads may be removed from the enabled-thread list 700. After a thread is executed, one or more tokens (determined by the thread engine 1102) may be added to the token list 704. The above-listed steps may be continued until the process is disabled or process iteration conditions are satisfied. In certain embodiments, a process may run indefinitely if no stop condition is specified. The token engine 1100 and thread engine 1102 may include all or part of the functionality of the token lookup table 706 and thread lookup table 708 previously described, except that the token engine 1100 and thread engine 1102 do not necessarily use lookup tables to provide their functionality.

The invention may be embodied in other specific forms without departing from its spirit or essential characteristics. The described examples are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for scheduling threads in a data processing system, the apparatus comprising:
a scheduling co-processor comprising:
at least one lookup table programmable with a Petri-net representation of a thread scheduling algorithm;
a token list to store tokens associated with the Petri-net;
an enabled-thread list listing threads that are enabled for execution in response to particular tokens being present in the token list; and
a ready-thread list indicating which threads from the enabled-thread list are ready for execution when at least one of data and space availability conditions for the threads are satisfied.

2. The apparatus of claim 1, wherein the at least one lookup table comprises:
a token lookup table to identify threads to add to the enabled-thread list when particular tokens are present in the token list; and
a thread lookup table to identify threads to remove from the enabled-thread list when a thread is moved from the enabled-thread list to the ready-thread list.

3. The apparatus of claim 2, wherein the thread lookup table further identifies tokens to add to the token list when a thread is executed.

4. The apparatus of claim 2, wherein the thread lookup table further identifies at least one of data and space availability conditions that must be satisfied before a thread is moved from the enabled-thread list to the ready-thread list.

5. The apparatus of claim 2, wherein the thread lookup table further identifies the priority of execution for threads identified in the thread lookup table.

6. The apparatus of claim 2, wherein the thread lookup table further stores parameters required to execute each thread.

7. The apparatus of claim 2, wherein the token lookup table further identifies tokens to be deleted from the token list when a thread is added to the enabled-thread list.

8. The apparatus of claim 2, wherein the token lookup table is indexed by tokens in the token list.

9. The apparatus of claim 2, wherein the token lookup table is implemented in a content-addressable memory (CAM).

10. The apparatus of claim 1, wherein at least one of the token list, the enabled-thread list, and the ready-thread list are stored in a register of the scheduling co-processor.

11. A method for scheduling threads in a data processing system, the method comprising:
gathering tokens in a token list implemented in hardware;
adding a first thread to an enabled-thread list when particular tokens are present in the token list;
moving the first thread to a ready-thread list, indicating that the first thread is ready for execution, when at least one of data and space availability conditions associated with the first thread are satisfied; and
executing the first thread.

12. The method of claim 11, wherein adding the first thread comprises identifying the first thread in a token look up table indexed by tokens in the token list.

13. The method of claim 12, wherein the token lookup table is implemented in a content-addressable memory (CAM).

14. The method of claim 11, further comprising deleting at least one second thread from the enabled-thread list upon moving the first thread to the ready-thread list.

15. The method of claim 14, wherein deleting the least one second thread from the enabled-thread list comprises identifying the second thread in a thread lookup table.

16. The method of claim 11, wherein executing the first thread further comprises adding tokens to the token list.

17. The method of claim 11, wherein adding the first thread to the enabled-thread list further comprises deleting tokens from the token list.

18. The method of claim 11, wherein at least one of the token list, the enabled-thread list, and the ready-thread list are stored in at least one hardware register.

19. The method of claim 11, wherein executing the first thread comprises identifying the execution priority of the first thread.

20. The method of claim 11, wherein executing the first thread comprises identifying execution parameters associated with the first thread.

21. An apparatus for scheduling threads in a data processing system, the apparatus comprising:
a scheduling co-processor comprising:
at least one engine programmed with a Petri-net representation of a thread scheduling algorithm;
a token list to store tokens associated with place nodes of the Petri-net; and
an enabled-thread list to represent transition nodes in the Petri-net to respond to particular tokens being present in the token list.

22. The apparatus of claim 21, the scheduling co-processor further comprising a ready-thread list indicating which threads from the enabled-thread list are ready for execution when selected data processing conditions are met.

23. The apparatus of claim 22, wherein the at least one engine comprises:
a token engine to identify threads to add to the enabled-thread list when particular tokens are present in the token list; and
a thread engine to identify threads to remove from the enabled-thread list when a thread is moved to the ready-thread list from the enabled-thread list.
